(19) United States
(12) Patent Application Publication
(10) Pub. No.: US 2008/0237060 A1
(43) Pub. Date: Oct. 2, 2008

(54) METHODS AND APPARATUS FOR ELECTROLYTIC TREATMENT OF WATER

(76) Inventors: Rudolph R. Hegel, Richfield, MN (US); Robert K. Sorensen, Champlin, MN (US); Robert T. Ruminsky, Bloomington, MN (US); Karl J. Fritze, Hastings, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 12/055,723

(22) Filed: Mar. 26, 2008

Related U.S. Application Data
(60) Provisional application No. 60/920,247, filed on Mar. 27, 2007.

(51) Int. Cl. C02F 1/46

(52) U.S. Cl. 205/744; 204/242; 204/229.8

(57) ABSTRACT

Apparatus and related methods for increasing dissolved oxygen levels in water to remove iron and/or manganese. A dissolved oxygen treatment system includes a control system having a power supply and an electrode placed within a water chamber. At the electrode, water is converted into hydrogen gas and oxygen gas, wherein the oxygen gas remains in solution and increases the concentration of dissolved oxygen gas in the water. The dissolved oxygen treatment system can be manually configurable wherein the electrode is selectively wired to use either portions of or the whole electrode based upon testing of the water source with a dynamic electrode test system. Alternatively, the dissolved oxygen treatment system can include a smart controller, a variable power supply and a fixed size electrode, wherein the smart controller continually controls the power output to the fixed size electrode so as to control the amount of dissolved oxygen that is generated.

### RELATED APPLICATION

The present application claims the benefit of U.S. Provisional Application No. 60/920,247 filed Mar. 27, 2007, and entitled “METHOD AND APPARATUS FOR ELECTROLYTIC TREATMENT OF WATER”, which is incorporated herein in its entirety by reference.

### FIELD OF THE INVENTION

This invention relates to the field of water treatment using an electrolytic chamber to generate oxygen for oxidation and precipitation of toxic and non-hazardous metals for subsequent filtering. More specifically, the present invention is directed to a treatment apparatus and related methods for maximizing the useful life of the electrolytic chamber and minimizing power consumption during generation of oxygen for water sources having varying levels of contaminants.

### BACKGROUND OF THE INVENTION

The presence of non-hazardous dissolved metals such as iron and manganese can lead to a variety of problems for water users. With water sources having low amounts of dissolved oxygen such as, for example, deep wells, iron and/or manganese is generally present in a dissolved state having little to no effect on the appearance of the water. However, upon exposure to oxygen, the iron and manganese undergoes an oxidation reaction that results in the precipitation of the iron and manganese into visible, solid particulates. When dissolved iron is oxidized, red-brown colored particles are formed which, dependent upon size, may settle out of the water or remain suspended as colloidal iron. The oxidation of dissolved manganese generally results in a black tinted particulate.

In a residential environment, the presence of oxidized iron and manganese can lead to both taste and aesthetic issues. When water includes oxidized iron and/or manganese, an individual will notice a distinct flavor in water and in beverages prepared from such water, as well as an orange or black appearance that can stain appliances and fixtures. In higher volume commercial and industrial settings, iron can lead to fouling of piping and downstream water treatment equipment. In addition to these problems, a variety of bacteria strains can feed off iron and/or manganese in water resulting in the formation of slime within piping and tanks that can lead to clogging and performance issues.

Due to the problems associated with the presence of iron and/or manganese in water, a variety of treatment techniques have been developed to remove the iron and/or manganese. In one common technique, the iron and/or manganese can be exposed to a chemical oxidizing agent such as chlorine bleach, hydrogen peroxide or ozone so as to force any dissolved iron to precipitate for subsequent filtration. In yet another technique, iron can be filtered through a media filter having “greensand” which reacts with soluble iron and manganese to form insoluble iron and manganese which is physically retained within the media. The ion exchange techniques of conventional water softeners can be used to exchange soluble iron and/or manganese with sodium. Finally, phosphate compounds can be introduced so as to surround soluble iron and/or manganese with complex molecule that physically prevents exposure of the soluble iron and/or manganese to oxygen so as to retain the iron and/or manganese in a soluble state. While each of the above techniques can be successfully employed, they all suffer from various deficiencies which can limit their effectiveness and/or practicality.

The use of chemical oxidizing agents such as chlorine bleach and hydrogen peroxide requires users to purchase, store and periodically expose themselves to potentially harmful chemicals. The use of ozone requires an on-site ozone generator that can require significant capital investment as well as ongoing monitoring and maintenance. With “greensand”, the reactive properties occasionally need restoration through a regeneration process with a permanganate solution. Conventional softener resins are quickly exhausted by the present of soluble iron and/or manganese and will require frequent regenerations and in some instances, acid regeneration due to the presence of insoluble particulates becoming tightly bound to the ion exchange resin. The use of phosphate compounds does not remove the iron and/or manganese and as these phosphate compounds are not stable at higher temperatures, the iron and/or manganese can be released later where oxidation can occur. In addition, many jurisdictions have tight regulations regarding use of phosphates due to their contribution to excess nutrients in surface water.

In addition to these techniques, the present Applicants in a series of patent and patent applications including U.S. Pat. No. 6,689,262 and U.S. patent application Ser. Nos. 10/582,670, 10/732,326, 11/367,134, 11/810,540, all of which are herein incorporated by reference, have disclosed the use of an electrolytic element for generating and correspondingly, increasing the amount of dissolved oxygen in water. Previously disclosed benefits relating to the increased concentration of dissolved oxygen include increasing the survival rate of marine animals in a live well, waste water treatment and increasing the growth and yield of plants. As discussed previously and within Applicant's aforementioned applications and patents, increasing the concentration of dissolved oxygen also provides a mechanism for converting soluble iron and/or manganese into insoluble particulates that can be filtered with conventional barrier filtration techniques. While the Applicant's prior work has provided a firm foundation for the technology of increasing dissolved oxygen in water, further improvements and refinements would be beneficial so as to allow users to use dissolved oxygen to more efficiently remove iron and/or manganese depending upon variables including water source, water quality and the quantity of water being consumed.

### SUMMARY OF THE INVENTION

The present disclosure provides an apparatus and related methods of using said apparatus for increasing dissolved oxygen levels in water to remove iron and/or manganese. By increasing the dissolved oxygen concentrations, soluble iron and/or manganese undergo an oxidation reaction wherein the iron and/or manganese are converted to an insoluble form that can be filtered with a conventional barrier filtration system. Generally, a dissolved oxygen treatment system can comprise a control system including a power supply and an electrode placed within a water chamber. When the power supply provides power to the electrode, water is converted into hydrogen gas and oxygen gas, wherein said hydrogen gas tends to exit the water and accumulate for subsequent venting while the oxygen gas remains in solution and increases the concentration of dissolved oxygen gas in the water. In some embodiments, the dissolved oxygen treatment system can comprise a manually configurable treatment system wherein the electrode is selectively wired to use either portions of, or the whole electrode based upon testing performed on the water source with a dynamic electrode test system. In some embodiments, the dissolved oxygen treatment system can comprise a smart treatment system utilizing a smart controller, a variable power supply and a fixed size electrode, wherein the smart controller is capable of continually controlling the power output to the fixed size electrode so as to control the amount of dissolved oxygen that is generated.

In one aspect of the present disclosure, a manually configurable dissolved oxygen treatment system can comprise a control system, a water chamber and a configurable electrode. The configurable electrode can be wired so as to have a variety of different output configurations utilizing all of or portions of an electrolytic plate forming the configurable electrode. In one representative embodiment, the configurable electrode can be provided with wiring jacks allowing a user to select the use of the full electrolytic plate, one third of the electrolytic plate or two thirds of the electrolytic plate. Generally, the wiring arrangement of the electrolytic plate can be determined by testing the source water with a dynamic electrode testing system that simulates the actual performance of the electrode within the water. Such a system can be operated more efficiently in terms of power required to generate adequate amounts of dissolved oxygen gas.

In another aspect of the present disclosure, a smart dissolved oxygen treatment system can comprise a smart control system, a variable power supply, a water chamber, a fixed size electrode and a variety of sensors allowing for continuous monitoring and control of the electrode output by the smart control system. Using ongoing system measurements for temperature, conductivity and flow rate, the smart control system selectively controls the power output of the variable power supply such that the fixed size electrode generates the amount of dissolved oxygen necessary for treatment of the water. The smart control system can originally include standard factory settings based upon average water qualities of water to be treated, wherein the smart control system can then adjust operation based on the instantaneous and continuous measurements of system performance and/or water quality. In this way, the system is continually operated at peak efficiency relative to power consumed and dissolved oxygen generated. In addition, the smart control system can include an internal current limit so as to avoid over current situations that would otherwise cause a conventional power supply to shut down. With this internal current limit, dissolved oxygen is continually produced even if the true resistance of the water desires additional current.

In yet another aspect of the present disclosure, a method for removing iron and manganese from a water source can comprise generating a selected amount of dissolved oxygen to as cause any soluble iron and/or manganese to become insoluble and subject to removal by barrier filtration. In one embodiment, the method can further comprise dynamically testing the water source with an electrolytic plate to determine actual performance characteristics relative to the water source such that a configurable electrode can be selectively wired or chosen for a desired output from the configurable electrode. In another embodiment, the method can further comprise monitoring and adjusting system variables such as temperature, conductivity and flow rate such that a smart controller can continually control the power output to a fixed electrode so as to selectively control the amount of dissolved oxygen generated by the fixed electrode. The method can further comprise measuring a totalized flow of treated water such that the polarity of the electrode can be reversed only when necessary to remove scale buildup and to extend the useful life of the electrode.

In still another aspect of the present disclosure, a method for manually adjusting the amount of dissolved oxygen generated by an electrode can comprise wiring the electrode so as to use only a desired amount of the electrode based upon dynamic testing performed on the source water with an electrode testing system.

In another aspect of the present disclosure, a dynamic electrode testing system can comprise an electrolytic test sensor having the same electrolytic properties as a configurable electrode to be used in a dissolved oxygen treatment system. The dynamic electrode test system can comprise a power supply and a calibrated meter having a display portion including an indication arm and a portioned wiring arc. The portioned wiring arc can be broken into a plurality of distinct portions corresponding to the potential wiring configurations for the configurable electrode. The user can then place the electrolytic testing sensor within a sample of the source water to measure actual current draw. The amount of current drawn by the electrolytic test sensor is then displayed along the portioned wiring arc to dictate the wiring configuration for the configurable electrode.

As used through the present application, the term electrode refers an electrode unit capable of generating gaseous oxygen through the process of hydrolysis. Generally, the electrode unit comprises at least one anode electrode and at least one cathode electrode.

The above summary of the invention is not intended to describe each illustrated embodiment or every implementation of the present invention. The Figures and the detailed description that follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is a schematic diagram of a manually configurable dissolved oxygen treatment system according to an embodiment of the invention.

FIG. 2 is a wiring schematic for a manually configurable dissolved oxygen treatment system according to an embodiment of the invention.

FIG. 3 is a schematic diagram of a dynamic electrode test system according to an embodiment of the invention.

FIG. 4 is a plan view of the dynamic electrode test system of FIG. 3.

FIG. 5 is a plan view of a calibrated meter for the dynamic electrode test system of FIG. 3.

FIG. 6 is a graph of electrolytic plate current versus water conductivity for calibrating the dynamic electrode test system of FIG. 3.

FIG. 7 is a schematic diagram of a smart dissolved oxygen treatment system according to an embodiment of the invention.

FIG. 8 is a schematic diagram of a smart dissolved oxygen treatment system according to an embodiment of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE DRAWINGS

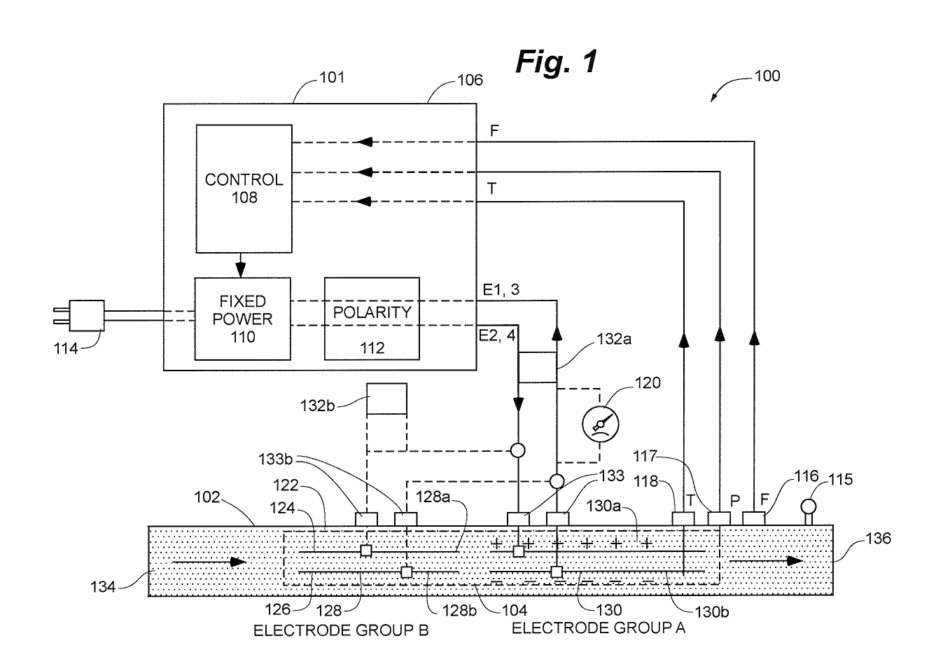

As illustrated in FIG. 1, an embodiment of a manually configurable dissolved oxygen treatment system 100 can comprise a control system 101, a water chamber 102 and a configurable electrode 104. Control system 101 generally comprises a cabinet 106 including a controller 108, a power supply 110, a polarity reversal switch 112 and an electrical connector 114. Water chamber 102 can comprise a pipe network fabricated of suitable material such as, for example, PVC tubing. Water chamber 102 generally includes a mechanical pressure relief valve 115 and a pressure switch 117 operably wired to the controller 108. Cabinet 106 can be fabricated of suitable materials including metal, plastic and combinations thereof, so as to prevent exposure of internal electrical components to water. In some instances, cabinet 106 can be fabricated of a transparent material or include one or more windows so as to provide users with an interior view so as to identify potential fault conditions.

Controller 108 can include any of a variety of suitable control types including a circuit board, a microprocessor based control, a Programmable-Logic-Controller (PLC) or terminal strip for managing various inputs and outputs to the manually configurable dissolved oxygen treatment system 100. As depicted in FIG. 1, a flow sensor 116 and a temperature sensor 118 can be mounted on or within the water chamber 102 so as to provide readings for consideration by the controller 108. A current sensor 120 can be operably positioned on the interconnecting wiring between the power supply 110 and the configurable electrode 104 to measure an instantaneous current draw of the configurable electrode 104.

Referring again to FIG. 1, configurable electrode 104 generally comprises an electrolytic plate 122 having an anode 124 and a cathode 126. Configurable electrode 104 is further divided into a plurality of plate sections illustrated as a one third plate section 128 and a two thirds plate section 130. Each of the plate sections 128 and 130 including a corresponding anode 128a, 130a and cathode 128b, 130b. The configurable electrode 104 generally comprises a substrate having a metal or metal oxide deposited thereon. In a preferred embodiment, the configurable electrode 104 comprises a titanium substrate coated with iridium/ruthenium oxide.

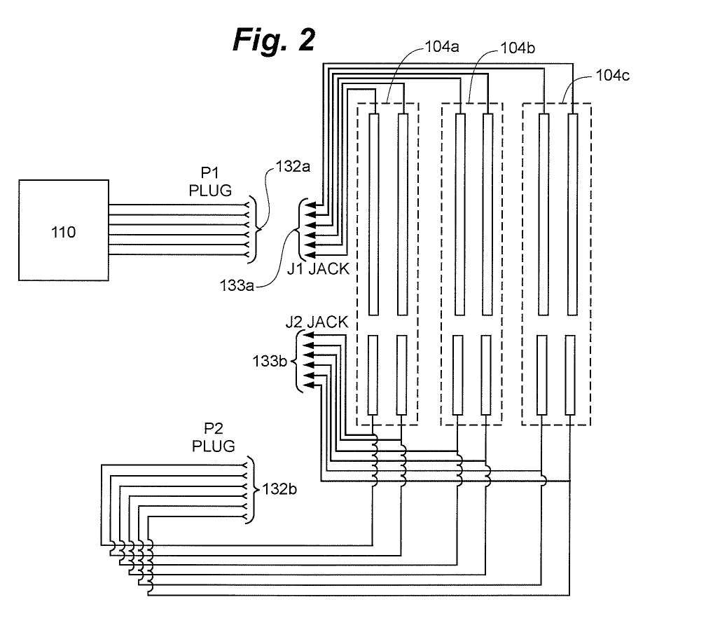

In one representative embodiment as illustrated in FIGS. 1 and 2, configurable electrode 104 can comprise a plurality of individual electrodes 104a, 104b, and 104c. Selective wiring of configurable electrode 104 can be accomplished utilizing a supply plug 132a, a jumper plug 132b, a first electrode jack 133a and a second electrode jack 133b. By selectively coupling the plugs and jacks, a user can quickly select a desired plate arrangement for connection to the power supply 110. Representative coupling arrangements are described in Table 1 below:

TABLE 1
Plug and Jack Configurations

| Desired Plate | |
|---|---|
| Arrangement | Coupling Arrangement |
| One Third Plate | Connect Supply Plug 132a to |
| | Second Electrode Jack 133b |
| Two Thirds Plate | Connect Supply Plug 132a to |
| | First Electrode Jack 133a |
| Full Plate | Connect Supply Plug 132a to |
| | Second Electrode Jack 133b and |
| | Connect Jumper Plug 132b to |
| | First Electrode Jack 133a |

To utilize manually configurable dissolved oxygen treatment system 100, a user generally connects the water chamber 102 to a water inlet 134 and a water outlet 136 as shown in FIG. 1. Manually configurable dissolved oxygen treatment system 100 is preferably installed upstream of a barrier filtration unit capable of removing insoluble iron and/or manganese in either a particulate or colloidal state. Suitable barrier filtration units can include media filter such as, for example, sand or greensand filters, or filter housings utilizing suitable filter elements. Electrical connector 114 can then be attached to an available electrical power source. Depending upon the environment in which manually configurable dissolved oxygen treatment system 100 is to be used, electrical connector 114 can comprise a conventional electrical plug or can comprise a junction box for establishing an essentially permanent electrical connection.

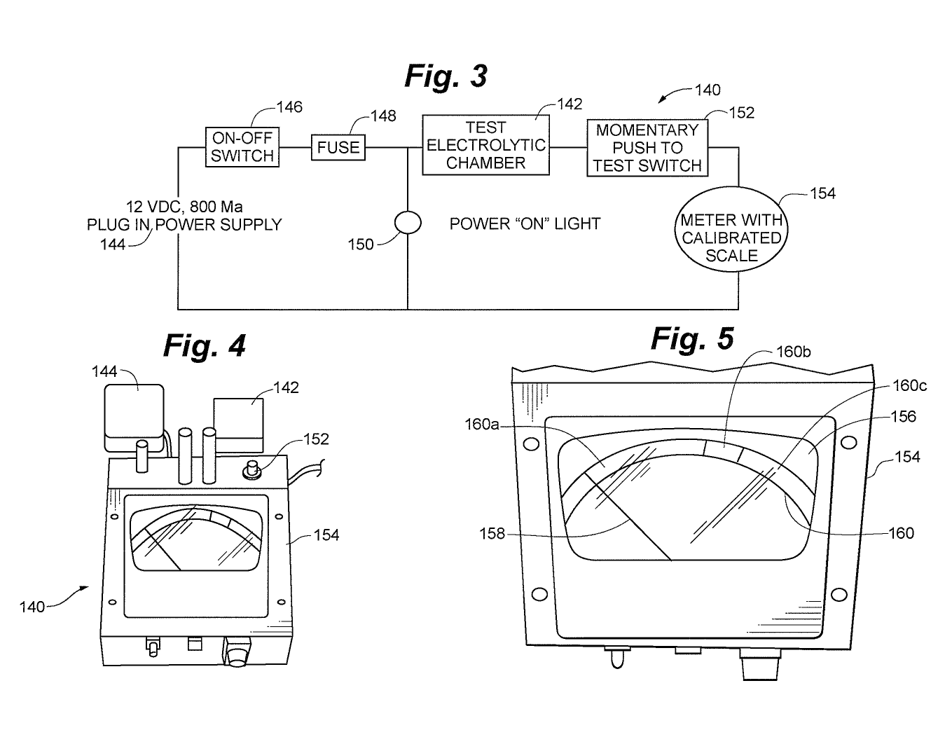

Prior to commencing water flow through the water chamber 102, a user can determine the appropriate electrolytic plate 122 arrangement based upon the properties of the water to be treated. As illustrated in FIGS. 3, 4 and 5, a dynamic electrode test system 140 can be used to test the conduction properties of the water to be treated with an electrolytic test sensor 142 having the same electrolytic properties as configurable electrode 104. The dynamic electrode test system 140 further comprises a power supply 144, an on/off switch 146, a fuse 148, a power on light 150, a push-to-test switch 152 and a calibrated meter 154. Power supply 144 can comprise a plug in style adapter capable of converting 110 volt AC power to 12 volt DC power and supplying 800 mA of current. Calibrated meter 154 generally includes a display portion 156 having an indication arm 158 and a portioned wiring arc 160. Portioned wiring arc 160 is generally divided into a plurality of portions corresponding to the potential wiring configurations for the configurable electrode 104. Portioned wiring arc 160 generally comprises an “A+B” (full plate arrangement) portion 160a, an “A” (two thirds plate arrangement) portion 160b and a “B” (one third plate arrangement) portion 160c.

To use dynamic electrode test system 140, an amount of water from the water source to be treated is placed in a container. Next, the electrolytic test sensor 142 is positioned within the water retained by the container. The user then presses on/off switch 146 such that the circuit is energized by power supply 144. As opposed to a simple conductivity or resistance measurement of the water, the electrolytic test sensor 142 measures an actual current draw by an electrolytic plate of the same construction as configurable electrode 104 such that actual performance in the water to be treated can be simulated. Measuring the actual performance of the electrolytic plate in the water to be treated is advantageous as testing conducted by the Applicants have determined that simply comparing conductivity or resistance measurements with a traditional conductivity sensor does not take into account the variation in dissolved salts that can result in the formation of different water sources that have similar conductivity readings. Without wishing to be bound by theory, it is Applicants' belief that differing ion types can affect the performance and current requirements of the electrolytic plates such that differing water sources having essentially equal conductivity or resistance readings perform differently with the electrolytic plate. The amount of current drawn by the electrolytic test sensor 142 is measured wherein the indication arm 158 is positioned along portioned wiring arc 160 to dictate which of the arc portions, for example, “A+B” (full plate arrangement) portion 160a, so as to provide suitable current to generate dissolved oxygen within the manually configurable dissolved oxygen treatment system 100. In instances wherein the indication arm 158 dictates wiring to the one third plate arrangement or the two thirds plating arrangement, the full capacity of configurable electrode 104 is not required, and as such, neither is the full power output of power supply 110. Based on the electrolytic test sensor 142 measurements, the configurable electrode can be wired as indicated in Table 1 providing for more efficient operation of the manually configurable dissolved oxygen treatment system 100.

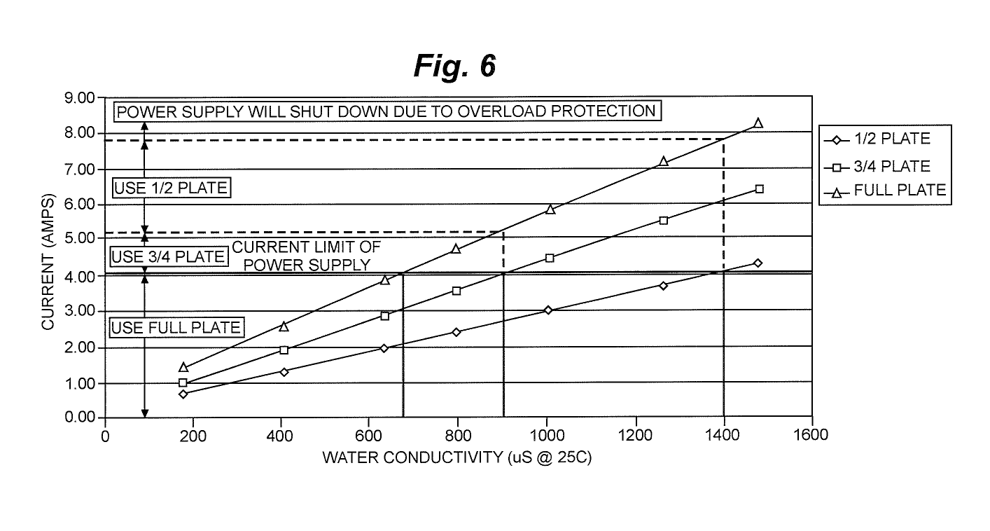

Generally, the portioned wiring arc 160 and the corresponding arc portions correspond to the plate current versus water conductivity data measured as described in the following examples and as graphically illustrated in FIG. 6.

### Plate Current V. Water Conductivity Testing

Protocol: An electrolytic test element was constructed having three sets of electrolytic plates arranged in a triangular configuration. The first plate set comprised a ½ plate arrangement having a total plate area of 14.34 in2. The second plate set comprised a ¾ plate arrangement having a total plate area of 21.69 in2. The third plate set comprised a full plate arrangement having a total plate area of 29.04 in2. Baking soda (sodium bicarbonate) in teaspoon increments was added to one gallon of distilled water to form water samples having different measured conductivities measured in microsiemens (μS). Testing was conducted on a benchtop in a no flow condition. Current was allowed to stabilize for approximately 10 seconds for each reading.

Test 1: Water Sample having conductivity of 176 μS at 25 C.

| | Plate Current (Amps) | | |
|---|---|---|---|
| | ½ Plate | ¾ Plate | Full Plate |
| Run 1 | 0.72 | 1.07 | 1.60 |
| Run 2 | 0.64 | 0.96 | 1.37 |
| Run 3 | 0.65 | 0.95 | 1.35 |
| Avg | 0.67 | 0.99 | 1.44 |

Test 2: Water Sample having conductivity of 406 μS at 25 C.

| | Plate Current (Amps) | | |
|---|---|---|---|
| | ½ Plate | ¾ Plate | Full Plate |
| Run 1 | 1.30 | 1.88 | 2.59 |
| Run 2 | 1.28 | 1.88 | 2.57 |
| Run 3 | 1.28 | 1.90 | 2.57 |
| Avg | 1.29 | 1.89 | 2.58 |

Test 3: Water Sample having conductivity of 635 μS at 25 C.

| | Plate Current (Amps) | | |
|---|---|---|---|
| | ½ Plate | ¾ Plate | Full Plate |
| Run 1 | 1.92 | 2.78 | 3.75 |
| Run 2 | 1.92 | 2.88 | 3.80 |
| Run 3 | 1.92 | 2.83 | 3.85 |
| Avg | 1.92 | 2.83 | 3.80 |

Test 4: Water Sample having conductivity of 798 μS at 25 C.

| | Plate Current (Amps) | | |
|---|---|---|---|
| | ½ Plate | ¾ Plate | Full Plate |
| Run 1 | 2.35 | 3.52 | 4.67 |
| Run 2 | 2.35 | 3.53 | 4.73 |
| Run 3 | 2.39 | 3.60 | 4.73 |
| Avg | 2.36 | 3.55 | 4.71 |

Test 5: Water Sample having conductivity of 1007 μS at 25 C.

| | Plate Current (Amps) | | |
|---|---|---|---|
| | ½ Plate | ¾ Plate | Full Plate |
| Run 1 | 2.96 | 4.49 | 5.83 |
| Run 2 | 2.97 | 4.42 | 5.80 |
| Run 3 | 2.98 | 4.44 | 5.86 |
| Avg | 2.97 | 4.45 | 5.83 |

Test 6: Water Sample having conductivity of 1264 μS at 25 C.

| | Plate Current (Amps) | | |
|---|---|---|---|
| | ½ Plate | ¾ Plate | Full Plate |
| Run 1 | 3.66 | 5.47 | 7.10 |

Test 7: Water Sample having conductivity of 1480 μS at 25 C.

| | Plate Current (Amps) | | |
|---|---|---|---|
| | ½ Plate | ¾ Plate | Full Plate |
| Run 1 | 4.23 | 6.34 | 8.10 |

TABLE 2
Summary of Tests 1-7:
Average Plate Current Readings (Amps)

| Sample | | | |
|---|---|---|---|
| Conductivity | | | |
| (μS) | ½ Plate | ¾ Plate | Full Plate |
| 176 μS | 0.67 | 0.99 | 1.44 |
| 406 μS | 1.29 | 1.89 | 2.58 |
| 635 μS | 1.92 | 2.83 | 3.80 |
| 798 μS | 2.36 | 3.55 | 4.71 |
| 1007 μS | 2.97 | 4.45 | 5.83 |
| 1264 μS | 3.66 | 5.47 | 7.10 |
| 1480 μS | 4.23 | 6.34 | 8.10 |

In addition to testing for a desirable plate configuration based on current plate readings, the dynamic electrode test system 140 can compensate for an operating water temperature. Generally, water is more conductive at higher temperatures. The temperature impact on water conductivity is generally expressed as the expression:

TV=IR/((T−25)*0.02+1)

where:

TV=True Value in μS/cm

IR=Actual reading in μS/cm

T=Temp at actual reading

Generally, TV @25C μS=1.7×TDS (Total Dissolved Solids in mg/L). Conductivity generally changes approximately 2% per degree Celsius (1.11% per degree Fahrenheit).

TABLE 3
Temperature Impact on Conductivity Measurements

| Water | Water | | Example |
|---|---|---|---|
| Temperature | Temperature | Correction | Conductivity |
| Centigrade | Fahrenheit | Factor | (μS) |
| 10 | 50.0 | 0.700 | 420 |
| 15 | 59.0 | 0.800 | 480 |
| 20 | 68.0 | 0.900 | 540 |
| 25 | 77.0 | 1.000 | 600 |
| 30 | 86.0 | 1.100 | 660 |
| 35 | 95.0 | 1.200 | 720 |
| 40 | 104.0 | 1.300 | 780 |

Once the configurable electrode 104 has been wired according to the measurements obtained by the dynamic electrode test system 140, the user can commence flow of the source water into water inlet 134. Generally, the flow sensor 116 begins measuring and transmitting flow rates to the controller 108. When the water flow exceeds a set minimum flow rate such as, for example, 0.5 gpm, the power supply 110 begins providing power to the configurable electrode 104. At rates below 0.5 gpm, operation of the power supply 110 is interrupted and/or prevented. As the electrolytic plate 122 receives power, bubbles of hydrogen gas are generated at cathode 126 and bubbles of oxygen gas are generated at anode 124 according to the following reactions:

AT THE CATHODE: 4H₂O+4e⁻→4OH⁻+2H₂

AT THE ANODE: 2H₂O→O₂+4H⁺+4e⁻

NET REACTION: 6H₂O→4OH⁻+4H⁺+2H₂+O₂

The small bubbles of oxygen gas tend to dissolve rapidly and remain in suspension while the hydrogen gas can escape the water stream in low pressure situations and accumulate at a highest point of the water chamber 102 or remain suspended in the water stream at typical water system pressures. If excess gasses such as hydrogen, oxygen and chorine accumulate, the pressure can reach a maximum pressure wherein the gas is subsequently vented through mechanical pressure relief valve 115. The oxygen gas increases the overall dissolved oxygen within the water stream causing any soluble iron and/or manganese to be rapidly oxidized to an insoluble form for later removal. As water flows through the water chamber 102, the temperature sensor 118 continually monitors the water temperature such that if the water temperature increases above a maximum set point due either to low flow conditions or high power input typically set at approximately 105° F., the controller 108 can shut down the manually configurable dissolved oxygen treatment system 100. In addition, the current sensor 120 constantly monitors the current draw of the configurable electrode 104 and if said current draw exceeds a set percentage of the capacity of power supply 110, the controller 108 shuts down the manually configurable dissolved oxygen treatment system 100. In the event that the configurable electrode 104 draws enough current to initiate a shutdown, this can provide an indication that a water quality change has occurred and that the configurable electrode 104 requires a rewiring adjustment based on updated testing with the dynamic electrode test system 140.

Over a period of time, the generation of dissolved oxygen within the manually configurable dissolved oxygen treatment system 100 results in scale build up at the anode 124 and cathode 126, which decreases the current draw of the configurable electrode 104. In order to address the scaling issue, a simple timer, based solely on elapsed time or based on time elapsed while flow is sensed by flow sensor 116 can cause polarity reversal switch 112 to reverse the power delivered to the configurable electrode 104 such that anode 124 and cathode 126 are reversed. Alternatively, flow sensor 116 either individually or in combination with controller 108 can totalize the water flow through the manually configurable dissolved oxygen treatment system 100 such that after a set number of gallons the polarity reversal switch 112 reverses the power delivered to the configurable electrode 104. Upon said reversal, the configurable electrode 104 is essentially “cleaned” as the previously attached scale is cleansed by the reversal of localized pH conditions at the new anode 124 and cathode 126. When said polarity reversal occurs, a portion of the metal or metal oxide on the substrate is vaporized. After enough reversals, the configurable electrode 104 is essentially worn out such that current draw decreases resulting in reduced oxygen generation wherein the water is essentially untreated and electrode 104 requires replacement. By basing the polarity reversal on actual gallons through the manually configurable dissolved oxygen treatment system 100, the life of configurable electrode 104 is extended as compared to time-based polarity reversal systems in which polarity is reversed regardless of whether or not water has been treated, and consequently, scale has been accumulated at anode 124 and cathode 126.

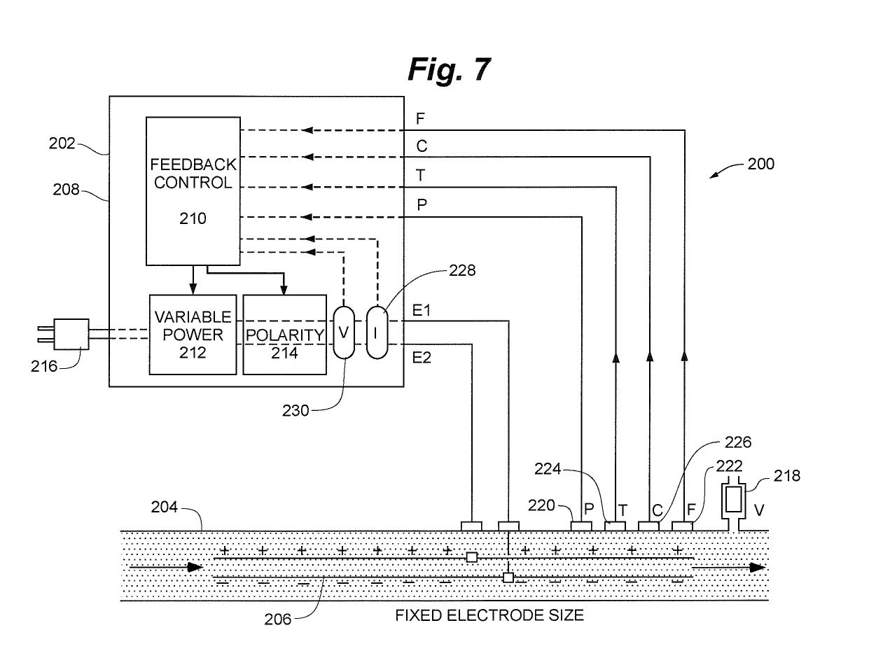

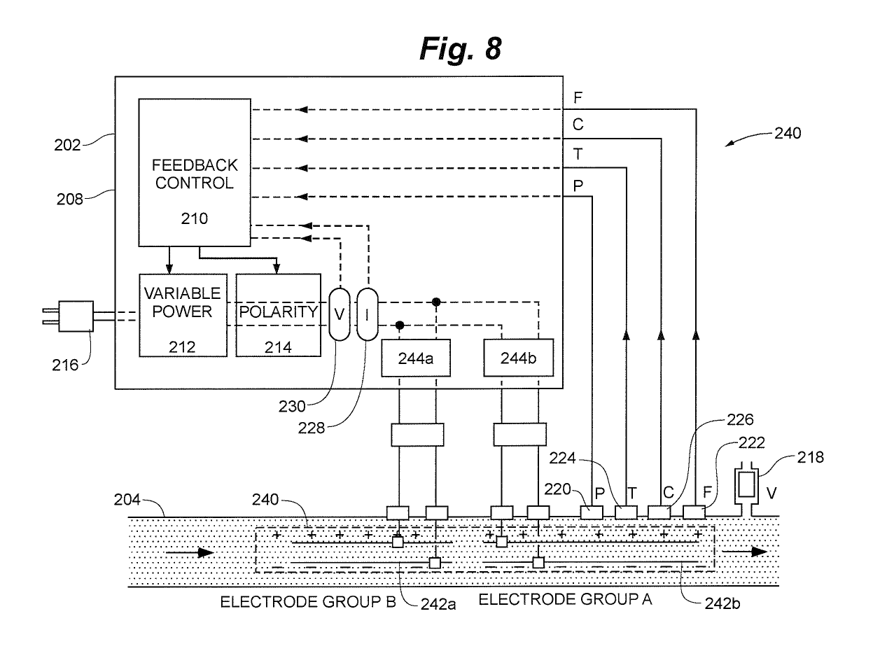

An embodiment of a smart dissolved oxygen treatment system 200 is illustrated generally in FIG. 7. Smart dissolved oxygen treatment system can comprise a feedback control system 202, a water chamber 204 and a fixed size electrode 206. Feedback control system 202 generally comprises a cabinet 208 including a smart controller 210, a variable power supply 212, a polarity reversal switch 214 and an electrical connector 216. Water chamber 204 can comprise a pipe network fabricated of suitable material such as, for example, PVC tubing. Water chamber 204 generally includes a mechanical pressure relief valve 218 and a pressure switch 220 operably wired to the smart controller 210. Pressure switch 220 can provide warning of high pressure conditions to smart controller 210. Cabinet 208 can be fabricated of suitable materials including metal, plastic and combinations thereof, so as to prevent exposure of internal electrical components to water. In some instances, cabinet 208 can be fabricated of a transparent material or include one or more windows so as to provide users with an interior view so as to identify potential fault conditions. Smart controller 210 can include any of a variety of suitable smart control types including a microprocessor based control for managing various inputs and outputs to the smart dissolved oxygen treatment system 200.

As depicted in FIG. 7, smart dissolved oxygen treatment system 200 generally comprises at least a flow sensor 222 operably to mounted to or within water chamber 204 such that feedback control 210 receives an input as to when a fluid is flowing through water chamber 204. In addition, a temperature sensor 224 and a conductivity sensor 226 can be mounted on or within the water chamber 204 so as to provide constant system feedback for evaluation by the smart controller 210. In some embodiments, the information provided by conductivity sensor 226 can be taken directly from current measurements of fixed size electrode 206. Smart dissolved oxygen treatment system 200 can include additional sensors for improving the operation and efficiency of smart controller 210 including, for example, sensors capable of measuring and transmitting fluid pressure, dissolved oxygen levels, iron levels, manganese levels and the like. A current sensor 228 and a voltage sensor 230 can be operably positioned on the interconnecting wiring between the variable power supply 212 and the fixed size electrode 206 to continuously measure an instantaneous current draw and operation voltage of the fixed size electrode 206.

Referring again to FIG. 7, fixed size electrode 206 substantially resembles the construction of configurable electrode 104 with the exception that the electrolytic plate 122 within fixed size electrode 206 comprises a single plate section as opposed to multiple plate sections. With fixed size electrode 206, smart controller 210 selectively controls the output of fixed size electrode 206 by continually monitoring the operation conditions within the smart dissolved oxygen treatment system 200 including temperature, conductivity, current draw and supply voltage such that the controller continually adjusts the power output of variable power supply 212. Voltage can be controlled by analog amplification and/or pulse width modification. As the output of fixed size electrode 206 is continually adjusted and set by smart controller 210, there is no requirement for wiring the electrode to utilizing only a portion of the electrolytic plate as is contemplated for manually configurable dissolved oxygen treatment system 100.

During assembly of the smart dissolved oxygen treatment system 200, a series of look-up tables can be stored within the smart controller 210 corresponding to the testing previously described for dynamic electrode test system 140. At time of shipment, the smart controller 210 can be set to factory settings corresponding to the type of water to be treated by the smart dissolved oxygen treatment system 200, such as, for example, well water with typical levels of iron and/or manganese found in well water sources.

While manually configurable dissolved oxygen system 100 and smart dissolved oxygen system 200 share many of the same basic principles of operation, the use of smart controller 210 can provide for additional operational efficiencies and continually adjust performance as the fixed size electrode 206 ages and/or becomes fouled with scale at the anodes and cathodes or even accommodate changes in the quality of the water supply. Smart dissolved oxygen system 200 generally begins treatment based on the standard factory settings for power output but due to the continual monitoring and input to the smart controller 210 provided by flow sensor 222, temperature sensor 224, conductivity sensor 226, current sensor 228 and voltage sensor 230, the power output from the variable power supply 212 can be constantly adjusted to control the amount of dissolved oxygen generated by fixed size electrode 206.

As illustrated in FIG. 8, another representative embodiment of a smart dissolved oxygen treatment system 240 can combine the advantages of the manually configurable dissolved oxygen system 100 and the smart dissolved oxygen system 200. Smart dissolved oxygen treatment system 240 essentially utilizes the smart controller 210 and the feedback information supplied by flow sensor 222, temperature sensor 224, conductivity sensor 226, current sensor 228 and voltage sensor 230 such that the variable power supply 212 selectively powers a desired portion of a configurable electrode 242. For example, configurable electrode 242 can be prewired in a ⅓ plate arrangement 242a or a ⅔ plate arrangement 242b, wherein based upon measured conductivities of the fluid, the variable power supply 212 selectively supplies a ⅓ relay 244a or a ⅔ relay 244b with a desired amount of power to either the ⅓ plate arrangement 242a or the ⅔ plate arrangement 242b. In this way, the smart controller 210 can operate the configurable electrode 242 at desired current densities such that overall life of the configurable electrode 242 is extended. For instance, in high resistance/low conductivity water it may be desirable to operate the smaller ⅓ plate arrangement 242a at a higher current density utilizing less power as such high resistance/low conductivity water will have less dissolved solids for oxidization by the smart dissolved oxygen treatment system 240.

While the invention has been described throughout the above description in connection with what is presently considered to be the most practical and preferred embodiments, it will be apparent to those of ordinary skill in the art that the invention is not to be limited to the disclosed embodiments, that many modifications and equivalent arrangements may be made thereof within the scope of the invention, which scope is to be accorded the broadest interpretation of the appended claims so as to encompass all equivalent structures and products.

What is claimed:

1. A real-time electrolysis-based fluid treatment system comprising:
a control system having a controller and a power supply;
a fluid chamber containing at least one electrode; and
a feedback loop having at least one flow sensor for monitoring a fluid flow rate within the water chamber,
wherein the feedback loop supplies fluid flow rate information from the at least one flow sensor to an input side of the controller; and
wherein the controller provides an output for controlling power supplied to the at least one electrode from the power supply based upon processing of the fluid flow rate information by the controller.

2. The real-time electrolysis-based fluid treatment system of claim 1, wherein the feedback loop comprises at least one additional sensor, the at least one additions sensor being selected from the group consisting essentially of; a temperature sensor, a current sensor, a conductivity sensor, a pressure sensor and an ion specific sensor.

3. The real-time electrolysis-based fluid treatment system of claim 2, wherein the controller provides the output for controlling power to the at least one electrode from the power supply based upon processing fluid flow rate information and additional information supplied by the at least one additional sensor by the controller.

4. The real-time electrolysis-based fluid treatment system of claim 1, wherein the control system comprises a polarity reversal switch.

5. The real-time electrolysis-based fluid treatment system of claim 1, wherein the fluid chamber comprises a pipe or tubing network.

6. The real-time electrolysis-based fluid treatment system of claim 1, wherein the control system comprises a current sensor and a voltage sensor operably connected between the power supply and the at least one electrode, and wherein the current sensor and the voltage sensor each supply instantaneous power data of the at least one electrode to the controller.

7. The real-time electrolysis-based fluid treatment system of claim 1, wherein the at least one electrode comprises a fixed electrode.

8. The real-time electrolysis-based fluid treatment system of claim 7, wherein the power supply comprises a variable power supply and where the controller manipulates the variable power supply such that an electrode output of the at least one fixed electrode is continually adjusted using analog amplification.

9. The real-time electrolysis-based fluid treatment system of claim 7, wherein the power supply comprises a variable power supply and where the controller manipulates the variable power supply such that an electrode output of the at least one fixed electrode is continually adjusted using pulse width modification.

10. The real-time electrolysis-based fluid treatment system of claim 1, wherein the at least one electrode is comprised of a pair of pre-configured electrode portions.

11. The real-time electrolysis-based fluid treatment system of claim 10, wherein the controller selectively directs the power supply to supply power to one or more of the pair of pre-configured electrode portions based upon processing of the fluid flow rate information by the controller.

12. A method for electrolytically treating water comprising:
providing a water chamber into which at least one electrode is mounted;
powering the at least one electrode so as to electrolytically generate bubbles of oxygen within the water chamber;
monitoring operational conditions within the water chamber with at least one sensor in fluid communication with the water chamber; and
adjusting a power supply to the at least one electrode based upon the operational conditions as measured by the at least one sensor.

13. The method of claim 12, further comprising:
switching polarity of the at least one electrode based upon operational data.

14. The method of claim 12, further comprising:
venting excess gas generated by the at least one electrode.

15. The method of claim 12, further comprising:
measuring current and voltage conditions of power supplied to the at least one electrode.

16. The method of claim 12, further comprising:
directing a fluid continually past the at least one electrode.

17. The method of claim 16, wherein the water chamber comprises a piping network.

18. The method of claim 12, further comprising:
compensating for a measured water temperature when adjusting the power supply.

19. The method of claim 12, further comprising:
selecting a pre-wired portion of the at least one electrode to supply power to based upon the measured operational conditions.
